(19) United States
(12) Patent Application Publication
(10) Pub. No.: US 2026/0290990 A1
(43) Pub. Date: Sep. 24, 2026

(54) ON VEHICLE MOISTURE PURGE SYSTEM FOR BATTERY ENCLOSURES

(71) Applicant: GM Global Technology Operations LLC, Detroit, MI (US)

(72) Inventors: Ryan Patrick Hickey, New York, NY (US); Adam Jonathan Tallman, Auburn Hills, MI (US); Robel Kiflemariam, West Bloomfield, MI (US)

(21) Appl. No.: 19/087,943

(22) Filed: Mar. 24, 2025

(51) Int. Cl. H01M 50/333; H01M 10/48; H01M 10/52; H01M 50/30

(52) U.S. Cl. CPC H01M 50/333; H01M 10/48; H01M 10/52; H01M 50/394; H01M 2220/20

(57) ABSTRACT

A vehicle including a rechargeable energy storage system (RESS) including a RESS housing and at least one battery pack disposed within the housing. A purge air source is disposed within the vehicle and configured to generate a compressed air and connected to the rechargeable energy storage system housing via a purge air connection. A controller is controllably coupled to the RESS and the purge air source. The controller is configured to reduce a moisture level within the RESS housing by providing air from the purge air source to the RESS housing through the purge air connection.

### INTRODUCTION

The subject disclosure relates to systems for purging moisture from a battery pack of a vehicle, and in particular to such systems using on-vehicle air sources.

Vehicle battery packs, such as those used in electric vehicles and hybrid electric vehicles typically include one or more battery components stored within a case. The battery components can be subjected to moisture accumulation within the case resulting from condensation, coolant, ambient liquids (e.g. rain) and the like. Current battery pack architectures do not include a solution for actively or passively removing liquids once the liquid has formed within the pack. The presence of liquid within the battery pack can impair the functionality of the battery packs and require increased maintenance and downtime of the battery systems

Accordingly, it is desirable to provide a system for purging moisture and liquids from a vehicle battery pack.

### SUMMARY

In one exemplary embodiment a vehicle including a rechargeable energy storage system (RESS) including a RESS housing and at least one battery pack disposed within the housing. A purge air source is disposed within the vehicle and configured to generate a purge air and connected to the rechargeable energy storage system housing via a purge air connection. A controller is controllably coupled to the RESS and the purge air source. The controller is configured to reduce a moisture level within the RESS housing by providing air from the purge air source to the RESS housing through the purge air connection.

In addition to one or more of the features described herein the compressed air is drier than an internal air within the RESS housing.

In addition to one or more of the features described herein the RESS housing includes at least one vent, and wherein the at least one vent is configured to allow air within the RESS housing to pass out of the RESS housing in response to the air within the RESS housing exceeding a pressure of an ambient air surrounding the RESS housing by a threshold amount.

In addition to one or more of the features described herein the at least one vent includes a spring loaded, normally closed, vent.

In addition to one or more of the features described herein the at least one vent includes a semi-permeable membrane.

In addition to one or more of the features described herein the purge air source includes at least one of an air-ride suspension system, heating ventilation and cooling (HVAC) hardware, and a dedicated electrically powered compressor.

In addition to one or more of the features described herein the purge air connection includes a purge air reservoir.

In addition to one or more of the features described herein the purge air reservoir includes a supplemental compressor.

In addition to one or more of the features described herein the purge air connection includes an electrically powered air flow control valve, and wherein the electrically powered air flow control valve is controllably connected to the controller.

In addition to one or more of the features described herein the vehicle includes at least one moisture sensor at the RESS, the moisture sensor being configured to determine a humidity of air within the RESS.

In addition to one or more of the features described herein the at least one moisture sensor includes at least one machine learning based virtual sensor.

In addition to one or more of the features described herein the at least one moisture sensor includes at least one sensor disposed withing the RESS housing.

In addition to one or more of the features described herein the at least one moisture sensor includes at least one sensor disposed adjacent to the RESS housing.

In addition to one or more of the features described herein reducing the moisture level within the RESS housing by providing air from the purge air source to the RESS housing through the purge air connection comprises supplanting air within the RESS housing with drier air from the purge air source.

In addition to one or more of the features described herein reducing the moisture level within the RESS housing comprises decreasing a condensation rate within the RESS housing using the purge air, evaporating a standing liquid within the RESS housing into the purge air, and continuously supplanting the purge air with new purge air for a duration.

In addition to one or more of the features described herein reducing the moisture level within the RESS housing comprises increasing a pressure within the RESS housing using the purge air and draining at least a portion of a standing liquid through at least one vent.

In another exemplary embodiment a method is provided for reducing moisture within a rechargeable energy storage system (RESS) of a vehicle. The method includes continuously providing purge air from an on-vehicle purge air source to an RESS housing through a purge air connections. Air is vented from within the RESS housing through at least one normally closed vent.

In addition to one or more of the features described herein, the method includes storing purge air from the on-vehicle purge-air source within a purge air reservoir, and wherein continuously providing purge air from the on-vehicle purge air source to the RESS housing through the purge air connections comprising connecting the purge air reservoir to the purge air connection.

In addition to one or more of the features described herein continuously providing purge air from an on-vehicle purge air source to an RESS housing through a purge air connections comprising lowering a moisture content of air within the RESS housing to a negative condensation moisture level and evaporating a standing liquid in the RESS housing by maintaining the air in the RESS housing at the negative condensation level for a predetermined duration.

In addition to one or more of the features described herein the on-vehicle purge air source includes at least one of an air-ride suspension system, heating ventilation and cooling (HVAC) hardware, a dedicated electrically powered compressor.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a vehicle including a rechargeable energy storage system moisture reduction process;

FIG. 2 is a schematic representation of an RESS using purge air to remove moisture;

FIGS. 3A and 3B illustrate a first example of reducing moisture by lowering humidity in an RESS; and

FIGS. 4A and 4B illustrate a second example of reducing moisture by evaporating a standing liquid within an RESS.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As used herein, the term controller refers to a system including at least a processor and a memory, with the system being configured to perform or cause to be performed at least one operation. The system can be a dedicated controller including a single purpose processor and memory, a general control including one or more modules for performing the operation, a distributed system including multiple controllers in communication with each other and configured to control the operation, or any similar system.

According to a general embodiment of the systems described herein, a hardware based solution is provided to actively purge moist pack air and formed liquids within a battery pack to an ambient environment using air from one or more pressurized air sources on the vehicle. The pressurized air sources can include, but are not limited to, an air-ride suspension system, heating ventilation and cooling (HVAC) hardware, a dedicated electrically powered compressor, or any similar on-vehicle system. The pressurized air is provided into the battery pack through a purge air valve, with a pressure of the air provided to the battery pack being controlled by a corresponding vehicle controller according to any established pressure and/or flowrate control method. The pressurized air forces the air currently in the battery pack, out of the battery pack through one or more vents.

The air delivered to the battery pack is drier (has a lower humidity) than the air within the battery pack or the ambient air. The relative dryness of the purge air decreases the humidity within the battery pack. When condensation liquid has already formed within the battery pack, or when liquid from another source is present in the battery pack, continued delivery of relatively dry purge air through the purge air valve facilitates evaporation of the liquid. The evaporated liquid is then displaced out of the RESS 20 as the relatively dry purge air continues to be pumped into the RESS 20.

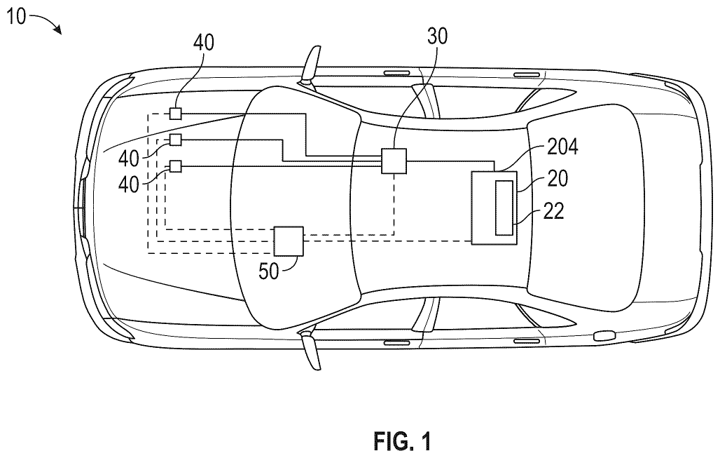

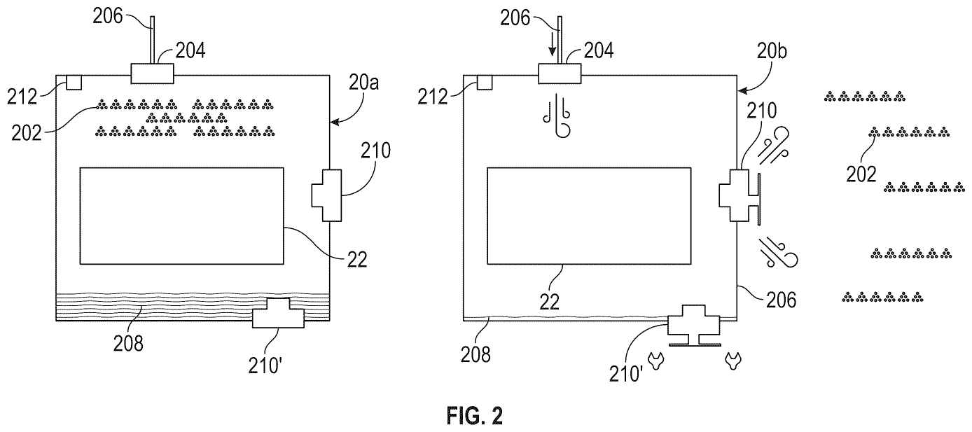

In accordance with an exemplary embodiment, FIG. 1 illustrates a vehicle 10 including a rechargeable energy storage system (RESS) 20. The RESS 20 is, in one example, a housing containing at least one battery component 22. A purge air reservoir 30 is connected to a purge air inlet (purge air inlet valve 204 illustrated in FIG. 2) of the RESS 20. The purge air reservoir 30 recieves and stores air from one or more vehicle systems 40 that are able to generate and/or utilize compressed air in their conventional operation. In one example, the one or more vehicle systems 40 includes an air ride system. In other examples, the one or more vehicle systems 40 can include any combination of an air-ride suspension system, heating ventilation and cooling (HVAC) hardware, a dedicated electrically powered compressor. In some examples, the pressurized air generated by the one or more vehicle systems 40 may not be sufficient to directly purge air in the RESS 20. In such examples, the purge air reservoir 30 stores pressurized air during operation of the one or more vehicle systems 40, and discharges the stored pressurized air when purge air is needed.

In yet further examples, the purge air reservoir may include a fan or other compressor component. The fan or other compressor component provides additional pressurization to the purge air. In some examples, one or more elements of a vehicle HVAC system may be utilized to provide the increased pressure via a connection to HVAC ducting.

In alternative examples, when the one or more vehicle systems 40 can provide a sufficient quantity and pressure of compressed air, the purge air reservoir may be omitted and the pressurized air can be provided directly to the purge air inlet 204 (illustrated in FIG. 2) of the RESS 20.

A vehicle controller (controller 50) is in communication with each of the at least one vehicle systems 40, the purge air reservoir 30 and the RESS 20. The controller 50 is configured to effectuate the processes described herein according to any conventional control processes.

With continued reference to the vehicle of FIG. 1, FIG. 2 illustrates an RESS 20 in an initial state (RESS 20a) and in a purged state (RESS 20b). The RESS 20 includes at least one purge air inlet valve 204 connected to the purge air reservoir 30 via a purge air conduit 206. In alternate examples two or more purge air inlets 204 may be included. Multiple vents 210 are disposed in the walls and base of the RESS 20.

In some examples the vents 210 are normally closed vents configured to open when a pressure differential between the air pressure within the RESS 20 and an ambient environment exceeds a threshold level. In one such example, the vents 210 are spring loaded vents, and the threshold level is determined by the spring force of a spring within the vent 210.

In some examples, the vents 210 are permeable membranes that allow an amount of flow through the membrane. In such examples, continued application of pressurized air to the RESS 20 ensures that a flow of air from inside RESS 20 through the membrane to the ambient atmosphere is maintained, thereby preventing backflow.

In some examples the vents 210 are placed on the RESS 20 to optimize fluid egress with respect to sensitive components (e.g., high voltage bussing, BDU etc.) that may be positioned adjacent to and/or near the RESS 20 on the vehicle 10.

In some examples, levels of moisture 202 and liquid 208 within the RESS 20 can be detected via sensors 212 within the RESS 20. In alternate examples, the moisture levels may be derived from other available sensor information.

In yet other examples, the moisture and liquid levels may be determined using a standard diagnostics and prognostics methodology used in automotive applications. In some examples, the moisture and liquid levels may be determined using a machine learning based virtual sensor. As used herein a machine learning based virtual sensor refers to a machine learning based algorithm trained to receive a set of data and predict a likely internal moisture level of the RESS 20 based on the received set of data. In some examples one or more data elements within the set of data does not directly correlate to moisture levels. The machine learning algorithm may, in some examples, be trained in a laboratory environment using a combination of empirical and simulation based data.

When the moisture levels exceed a threshold, or when a drying process is initiated as part of a scheduled operation and/or manually initiated, purge air is provided to a purge air conduit 206 through the valve 204. The purge air flows into the RESS 20b. The incoming purge air forces the moist air out through at least one of the vents 210, decreasing the moisture levels within the RESS 20b.

When standing liquid 208 has accumulated in the RESS 20, the purge air can further remove the liquid in addition to replacing the moist air with drier air. The liquid 208 can be removed through a vent 210′ positioned at a bottom wall (relative to gravitational forces) of the RESS 20. In this example, the increased pressure resulting from providing the drier air to the RESS 20 through the purge air connection 206 can force the liquid 208 directly out through the vent 210′.

In another example, the standing liquid 208 can be removed from inside the RESS 20 through evaporation. As the purge air is drier than the ambient air, and drier than the air currently within the RESS 20, the purge air picks liquid from the standing liquid 208. Continued purging moves the air including the evaporated liquid out through the vents 210 thereby reducing or eliminating the standing liquid 208.

In some examples, the RESS 20 may utilize a combination of directly purging the liquid through a vent 210′ in a bottom wall and evaporative purging to reduce the amount of liquid in the standing liquid 208.

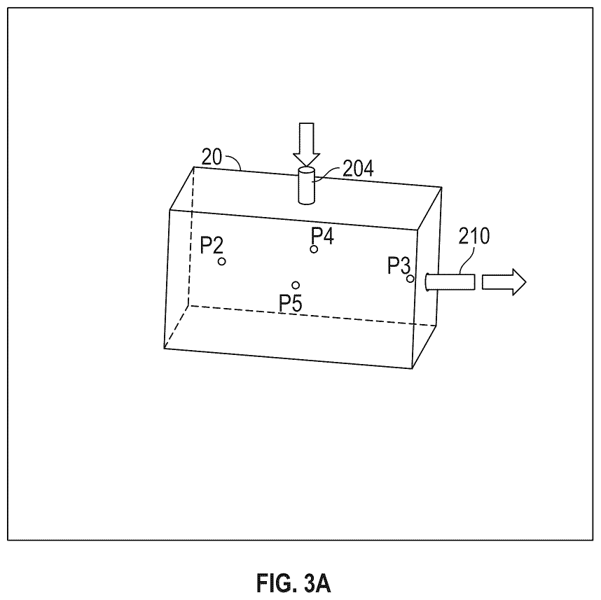

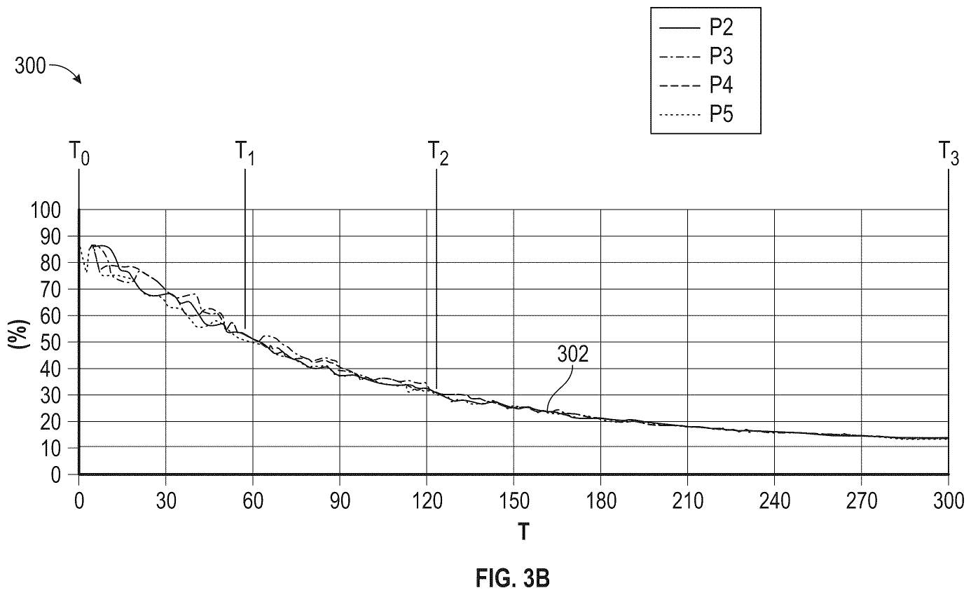

With continued reference to FIGS. 1-2, FIG. 3A schematically illustrates an RESS 20, including multiple humidity sensors (P2, P3, P4, P5). FIG. 3B is a chart 300 illustrating a humidity, measured as a relative humidity percent (RH %), over time of the RESS 20 of FIG. 3A as a purge process continues in one example.

Immediately prior to the purge air cycle, at T0 (0 seconds), the initial air in the RESS 20 is at an average of 90% humidity and 25 degrees Celsius (C) as measured by the humidity sensors P2, P3, P4, P5. Puge air begins being pumped through the purge air inlet valve 204 and into the RESS 20. In the example of FIGS. 3A and 3B, the purge air is provided from a pressurized purge air source with a relative humidity of 10% and at 25 degrees C. In on example, the purge air inlet valve 204 is an electrically powered and airflow control valve and is connected to the controller 50.

The pressurized purge air is continuously delivered to the RESS 20 and mixes with the initial air already inside the RESS 20. The mixed air is then forced out through the outlet valves 210 (schematically illustrated in FIG. 3A as a single outgoing airflow), thereby decreasing the average humidity of the air inside the RESS 20. The initial inrush of purge air provides a substantial reduction in humidity as shown from t0 to t1. As purge air is continuously circulated through the RESS 20, the relative humidity within the RESS 20 continues to decrease, with the rate of decrease slowing resulting in the curve 302 illustrated in chart 300. Once the relative humidity within the RESS 20 reaches the same relative humidity as the purge air (at time t3), the decline levels off.

Continued delivery of purge air after time t3 will maintain the lower relative humidity, but will not continuously lower the relative humidity below the relative humidity of the air being provided.

In a practical implementation, the slope of the chart 300 through times t0, t1, t2, and t3 can be generally determined via empirical testing and/or simulations and the chart may be stored in the controller 50. Multiple individual charts 300 at each of multiple temperature combinations (purge air temperature and initial RESS 20 air temperature) may be stored and referenced by the controller 50.

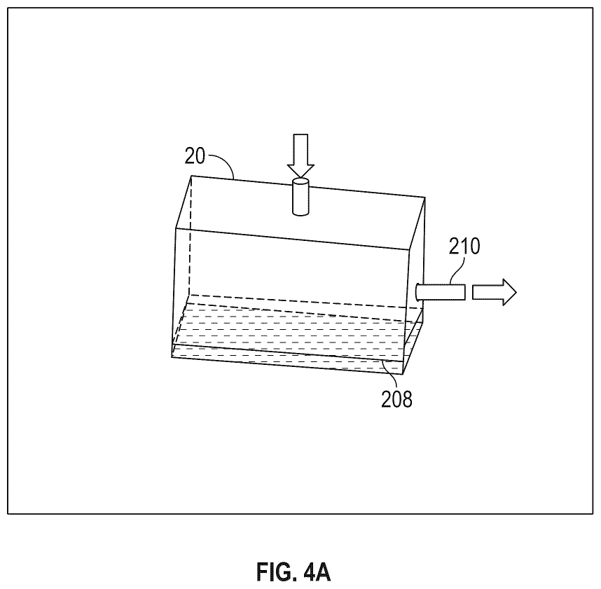

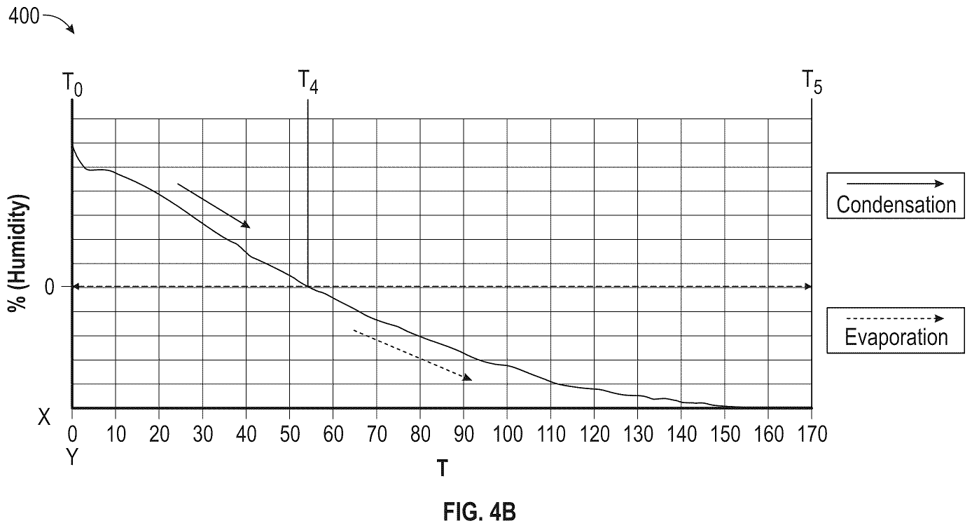

With continued reference to FIGS. 1-3B, FIG. 4A illustrates an RESS 20 having a liquid 208 accumulated in a base thereof. The liquid 208 is a result of condensation, incidental leakage through one or more vents 210 and/or any other liquid source. FIG. 4B illustrates a chart 400 of condensation rate (Y axis) over time (X axis). At an initial time (t0) the humidity level is high (see FIG. 3A, 3B) and the condensation rate is similarly elevated driving a continued increase in the level of liquid 208 within the RESS 20 due to condensation.

As purge air is delivered through the purge air inlet valve 204, the condensation rate decreases due to the decreased moisture content in the air, until a time (t4) where the condensation rate is 0. After reaching 0, the condensation rate continues to drop below 0, resulting in evaporation (i.e., negative condensation). Continued delivery of the drier air through the purge air inlet valve 204 will continue to drive evaporation until a maximum evaporation (minimum condensation) level is reached at t5.

As can be appreciated the maximum evaporation point t5 may be impacted by multiple factors including a dew point and it not necessarily the same point in time as the time (t3, chart 300 of FIG. 3B) where the RESS 20 reaches a minimum relative humidity. In such cases, the duration of a purge may exceed an amount of time required to reduce the humidity of the air within the RESS 20.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
a rechargeable energy storage system (RESS) including a RESS housing and at least one battery pack disposed within the housing;
a purge air source disposed within the vehicle and configured to generate a purge air and connected to the rechargeable energy storage system housing via a purge air connection; and
a controller controllably coupled to the RESS and the purge air source, the controller being configured to reduce a moisture level within the RESS housing by providing purge air from the purge air source to the RESS housing through the purge air connection.

2. The vehicle of claim 1, wherein the compressed air is drier than an internal air within the RESS housing.

3. The vehicle of claim 1, wherein the RESS housing includes at least one vent, and wherein the at least one vent is configured to allow air within the RESS housing to pass out of the RESS housing in response to the air within the RESS housing exceeding a pressure of an ambient air surrounding the RESS housing by a threshold amount.

4. The vehicle of claim 3, wherein the at least one vent includes a spring loaded, normally closed, vent.

5. The vehicle of claim 3, wherein the at least one vent includes a semi-permeable membrane.

6. The vehicle of claim 1, wherein the purge air source includes at least one of an air-ride suspension system, heating ventilation and cooling (HVAC) hardware, and a dedicated electrically powered compressor.

7. The vehicle of claim 1, wherein the purge air connection includes a purge air reservoir.

8. The vehicle of claim 7, wherein the purge air reservoir includes a supplemental compressor.

9. The vehicle of claim 1, wherein the purge air connection includes an electrically powered air flow control valve, and wherein the electrically powered air flow control valve is controllably connected to the controller.

10. The vehicle of claim 1, wherein the vehicle includes at least one moisture sensor at the RESS, the moisture sensor being configured to determine a humidity of air within the RESS.

11. The vehicle of claim 10, wherein the at least one moisture sensor includes at least one machine learning based virtual sensor.

12. The vehicle of claim 10, wherein the at least one moisture sensor includes at least one sensor disposed withing the RESS housing.

13. The vehicle of claim 10, wherein the at least one moisture sensor includes at least one sensor disposed adjacent to the RESS housing.

14. The vehicle of claim 1, wherein reducing the moisture level within the RESS housing by providing air from the purge air source to the RESS housing through the purge air connection comprises supplanting air within the RESS housing with drier air from the purge air source.

15. The vehicle of claim 1, wherein reducing the moisture level within the RESS housing comprises decreasing a condensation rate within the RESS housing using the purge air, evaporating a standing liquid within the RESS housing into the purge air, and continuously supplanting the purge air with new purge air for a duration.

16. The vehicle of claim 1, wherein reducing the moisture level within the RESS housing comprises increasing a pressure within the RESS housing using the purge air and draining at least a portion of a standing liquid through at least one vent.

17. A method for reducing moisture within a rechargeable energy storage system (RESS) of a vehicle, the method comprising:
continuously providing a purge air from an on-vehicle purge air source to an RESS housing through a purge air connection; and
venting air from within the RESS housing through at least one normally closed vent.

18. The method of claim 17, further comprising storing purge air from the on-vehicle purge-air source within a purge air reservoir, and wherein continuously providing purge air from the on-vehicle purge air source to the RESS housing through the purge air connections comprising connecting the purge air reservoir to the purge air connection.

19. The method of claim 17, wherein continuously providing purge air from an on-vehicle purge air source to an RESS housing through a purge air connections comprising lowering a moisture content of air within the RESS housing to a negative condensation moisture level and evaporating a standing liquid in the RESS housing by maintaining the air in the RESS housing at the negative condensation moisture level for a predetermined duration.

20. The method of claim 17, wherein the on-vehicle purge air source includes at least one of an air-ride suspension system, heating ventilation and cooling (HVAC) hardware, a dedicated electrically powered compressor.
